(19) United States
(12) Patent Application Publication
(10) Pub. No.: US 2025/0246701 A1
(43) Pub. Date: Jul. 31, 2025

(54) VEHICLE BATTERY CELL VENTING MANAGEMENT

(71) Applicant: Ford Global Technologies, LLC, Dearborn, MI (US)

(72) Inventors: Fan Wang, Downers Grove, IL (US); Jingmei Shen, Troy, MI (US); Enhui Liu, Ann Arbor, MI (US); Kevin Vander Laan, Bloomfield Hills, MI (US)

(21) Appl. No.: 18/425,061

(22) Filed: Jan. 29, 2024

(51) Int. Cl. H01M 10/52; H01M 4/02; H01M 4/505; H01M 4/525; H01M 10/44; H01M 50/105

(52) U.S. Cl. CPC H01M 10/52; H01M 10/445; H01M 2004/028; H01M 4/505; H01M 4/525; H01M 50/105; H01M 2200/20; H01M 2220/20

(57) ABSTRACT

A traction battery venting management method includes initiating a venting mitigation action that is based in part on an estimated volume of gas within at least one battery cell within a traction battery pack. Initiating the venting mitigation action can occur before a venting of the at least one battery cell.

### TECHNICAL FIELD

This disclosure relates to predicting a time when a vehicle battery cell will vent and, more particularly, to initiating a venting mitigation action in advance of that time.

### BACKGROUND

Electrified vehicles differ from conventional motor vehicles because electrified vehicles are selectively driven using one or more electric machines powered by a traction battery. The electric machines can drive the electrified vehicles instead of, or in addition to, an internal combustion engine.

### SUMMARY

In some aspects, the techniques described herein relate to a traction battery venting management method, including: initiating a venting mitigation action that is based in part on an estimated volume of gas within at least one battery cell within a traction battery pack.

In some aspects, the techniques described herein relate to a traction battery venting management method, wherein the venting mitigation action includes an adjusting of an upper state of charge limit for the at least one battery cell, the traction battery pack, or both.

In some aspects, the techniques described herein relate to a traction battery venting management method, wherein the venting mitigation action includes derating a maximum power capacity of the at least one battery cell, the traction battery pack, or both.

In some aspects, the techniques described herein relate to a traction battery venting management method, wherein the venting mitigation action includes derating a charging of the at least one battery cell, the traction battery pack, or both.

In some aspects, the techniques described herein relate to a traction battery venting management method, further including initiating the venting mitigation action before a venting of the at least one battery cell.

In some aspects, the techniques described herein relate to a traction battery venting management method, wherein the estimated volume of gas within the at least one battery cell is used to establish a predicted venting time for the at least one battery cell.

In some aspects, the techniques described herein relate to a traction battery venting management method, wherein the predicted venting time is at least partially based on estimating when a pressure of gas within the at least one battery cell will exceed a venting threshold value.

In some aspects, the techniques described herein relate to a traction battery venting management method, wherein the predicted venting time is based, at least in part, on both calendar aging and cycling aging.

In some aspects, the techniques described herein relate to a traction battery venting management method, further including establishing the estimated volume of gas by running a mathematical model

In some aspects, the techniques described herein relate to a traction battery venting management method, wherein the traction battery pack is a constituent of an electrified vehicle.

In some aspects, the techniques described herein relate to a traction battery venting management method, further including running a mathematical model at a start of a drive cycle for the electrified vehicle.

In some aspects, the techniques described herein relate to a traction battery venting management method, wherein the venting mitigation action includes servicing the electrified vehicle.

In some aspects, the techniques described herein relate to a traction battery venting management method, wherein the mathematical model is a semi-empirical mathematical model.

In some aspects, the techniques described herein relate to a traction battery venting management method, wherein running the mathematical model provides an estimate of gas volume by a power law with time.

In some aspects, the techniques described herein relate to a traction battery venting management method, wherein the at least one battery cell includes a lithium nickel manganese cobalt oxide cathode.

In some aspects, the techniques described herein relate to a traction battery venting management method, wherein the at least one battery cell is a pouch cell.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 illustrates a side view of an electrified vehicle having a traction battery pack.

FIG. 2 illustrates a perspective expanded view of the traction battery pack from FIG. 1.

FIG. 3 illustrates a schematic view of the electrified vehicle of FIG. 1.

FIG. 4 illustrates a flow of an example method of managing venting of battery cells within the traction battery pack of FIG. 2.

### DETAILED DESCRIPTION

This disclosure relates generally to managing venting of battery cells within a traction battery pack of an electrified vehicle and in particular, to taking a mitigation action in response a estimated volume of gas within one or more battery cells.

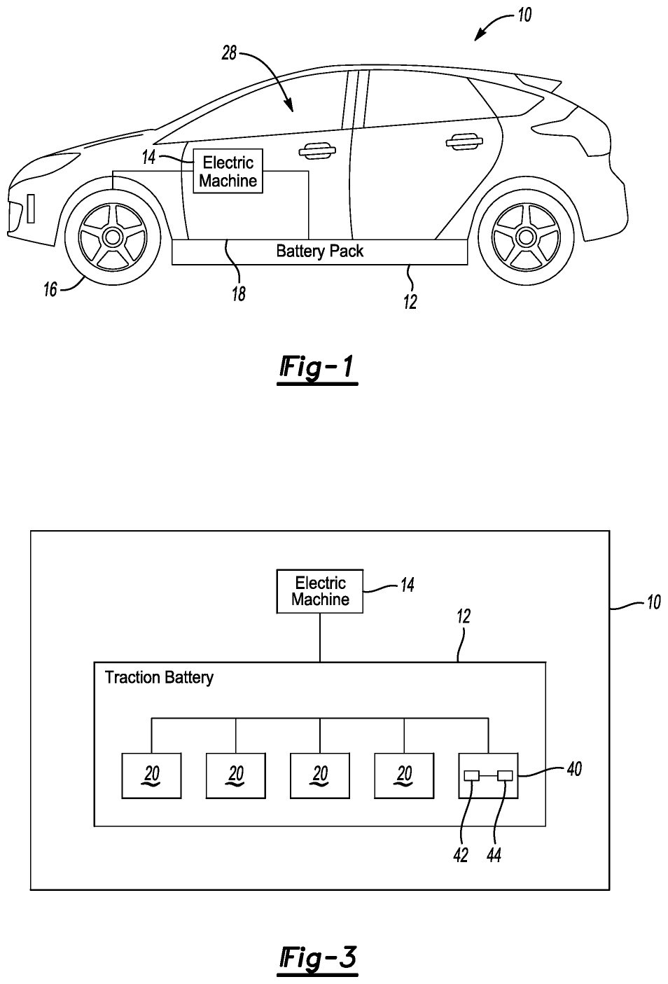

With reference to FIG. 1, an electrified vehicle 10 includes a traction battery pack 12, an electric machine 14, and wheels 16. The battery pack 12 powers an electric machine 14, which converts electric power to torque to drive the wheels 16. The battery pack 12 is a traction battery pack as the battery pack 12 is used for electric propulsion.

The battery pack 12 is, in the exemplary embodiment, secured to an underbody 18 of the electrified vehicle 10 beneath and outside a passenger compartment of the electrified vehicle 10. The battery pack 12 could be located elsewhere on the electrified vehicle 10 in other examples.

The example vehicle 10 is a battery electric vehicle (BEV). In another example, the vehicle 10 could be another type of electrified vehicle, such as a hybrid electric vehicle (HEV), plug-in hybrid electric vehicle (PHEV), or a conventional vehicle. A hybrid electric vehicle selectively drives wheels using torque provided by an internal combustion engine instead of, or in addition to, an electric machine. Generally, the electrified vehicle 10 could be any type of vehicle having a traction battery pack.

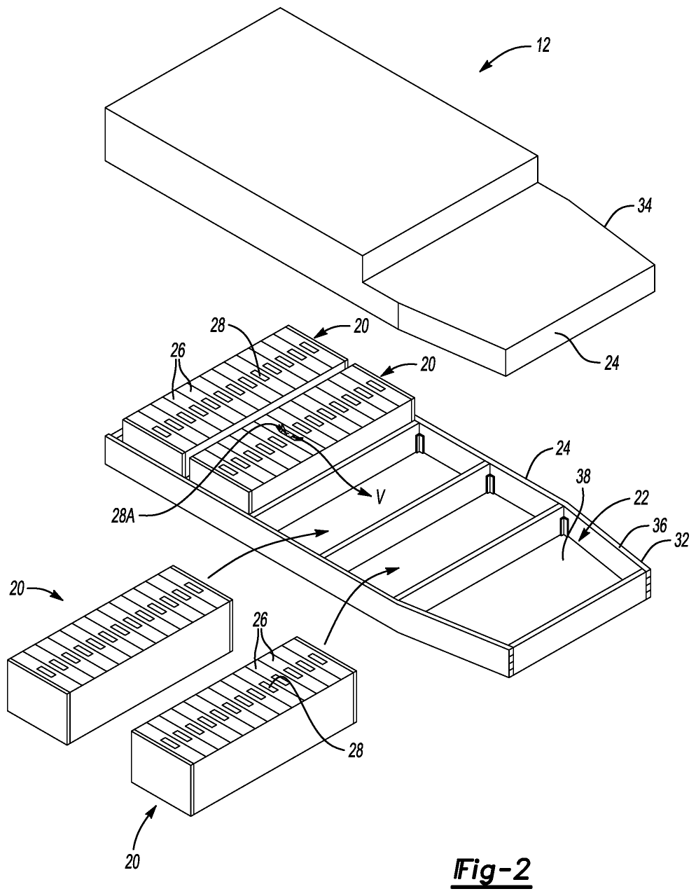

Referring now to FIG. 2 with continuing reference to FIG. 1, the battery pack 12 includes a plurality of battery arrays 20 housed within an interior 22 of an enclosure 24. The battery arrays 20 each include groups of individual battery cells 26 arranged in a rows. In an embodiment, the battery cells 26 are pouch cells, but battery cells having other geometries (cylindrical, prismatic, etc.) could alternatively be utilized within the scope of this disclosure. The example battery cells 26 are a lithium nickel manganese cobalt oxide cathode, but other chemistries (nickel-metal hydride, lead-acid, etc.) could be used.

From time to time, a thermal event may increase pressure and temperature in one of the battery cells 26. The increasing pressure and temperature can rupture a vent 28 of the battery cell 26 and release vent byproducts V from an interior of the battery cell 26 into the interior 22. FIG. 2 shows a single vent 28A ruptured, but the battery pack 12 can include more than one of the battery cells 26 venting at the same time.

With reference now to FIG. 3 and continuing reference to FIGS. 1 and 2, in the exemplary embodiment, the vehicle 10 includes a controller module 40 having processing unit 42 and a memory portion 44. The processing unit 42 can run a mathematical model as part of a program to estimate a volume of gas for each of the individual battery cells 26 within the battery pack 12. The mathematical model along with other programs can be saved in the memory portion 44. The estimate of the volume of gas can be used to establish a predicted venting time for those battery cells 26.

The controller module 40 is part of the vehicle 10 and, in particular, part of the battery pack 12. The controller module 40 can be a Battery Electronic Control Module (BECM) that is housed within the enclosure 24. In another example, the controller module 40 could be partially or entirely outside the vehicle 10. For example, some or all of the controller module 40 could be cloud-based.

The processing unit 42 can be programmed to run the mathematical model as part of a program that is stored in the memory portion 44. The program may be stored in the memory portion 44 as software code, for example. Each program stored in the memory portion 44 may include an ordered list of executable instructions for implementing logical functions at least some of which are associated with running the mathematical model to predicting when pressure within each of the battery cells 26 will increase to a level where the respective battery cell 26 will vent. The processing unit 42 could be programmed to run the mathematical model at the start of every drive cycle for the vehicle 10, for example.

The processing unit 42 can be a custom made or commercially available processor, a central processing unit (CPU), or generally any device for executing software instructions. The memory portion 44 can include any one or combination of volatile memory elements and/or nonvolatile memory elements.

The mathematical model run by the processing unit 42 is a semi-empirical model that estimates a volume of gas within each of the battery cells 26. The volume of gas is estimated by a power law with time for each of the battery cells 26. In some examples, Arrhenius-type temperature dependence and an exponential relation with state of charge for the battery cells 26 is considered in the power law prefactor. The mathematical model can model gas generation during cycling of the battery cells 26 using a correction term within a differential equation where effects of a depth of discharge for the battery cells 26 and a number of cycles for the battery cells 26 are considered.

The mathematical model can monitor and receive as inputs from each of the battery cells 26 information relating to state-of-charge, temperature, cycle number, and depth of discharge during both cell calendar aging and cycling aging. The cell-specific information can be calibrated against testing data by a stepwise method to minimize fitting errors and ensure fast convergence.

Running the mathematical model can include compare the estimated volume of gas to one or more threshold values. The time at which the estimated volume of gas exceeds a venting threshold value can be interpreted as the predicted time at which that battery cell will vent or the predicted venting time. The mitigation action can be taken when the estimated volume of gas exceeds a mitigation action threshold value.

As can be appreciated, the venting threshold value is higher than the mitigation action threshold value so that the mitigation action can be carried out before that battery cell vents. For example, if the venting threshold value for a given battery cell is 500 milliliters and it is desirable for the cell to avoid venting for ten years, mitigation actions may be desirable if the predicted gas volume exceeds 50 milliliters after just one year.

The venting threshold value can be temperature dependent where a high temperature leads to lower threshold. The mitigation action threshold value can be temperature dependent. The mitigation action threshold can be a dynamic trendline that increases gradually with time (e.g., 50 milliliters after one year, 100 milliliters after two years). The increase may not be linear. If the mitigation action leads to the estimated volume dropping back below the mitigation action threshold value, the mitigation action could be stopped.

While the mathematical model is used to estimate a volume of gas to establish the predicted venting time in this example, other examples could include establishing the predicted venting time for the battery cells 26 in other ways.

If the predicted venting time for one of the battery cells 26 is a relatively short time away, the program running on the controller module 40 can automatically initiate a venting mitigation action, which attempts to increase a time until that battery cell 26 vents. An example venting mitigation action can include an adjusting of an upper state of charge limit for the at least one battery cell 26, the traction battery pack 12, or both.

For example, the program running on the processing unit 42 could reduce the upper state of charge limit for that battery cell 26 from 100 percent to 85 percent. Such a change could extend the time unit the battery cell 26 vents beyond the predicted venting time calculated by running the mathematical model.

Another example venting mitigation action could include derating a maximum power capacity the battery cell 26, the traction battery pack 12, or both. Such a change could extend the time unit the battery cell 26 vents beyond the predicted venting time calculated by running the mathematical model.

Another example venting mitigation action could include derating a charging of the battery cell 26, the traction battery pack 12, or both. Such a change could extend the time unit the battery cell 26 vents beyond the predicted venting time calculated by running the mathematical model.

Other example venting mitigation actions can include the program communicating an alert about the predicted venting time. The alert could be a visual alert displayed within the vehicle or outside the vehicle 10. The visual alert could be a message to a mobile phone of the vehicle operator, or a visual alert displayed on a screen within the vehicle 10. In response to the alert, the operator could, for example, adjust an operating parameter that slows pressure build-up within that battery cell 26. The operator could instead or additionally service the vehicle 10.

Yet another mitigation action could include increasing a cooling of the battery pack 12. For example, in response to a predicted venting time or an estimated volume of gas, a set temperature for liquid cooling could be lowered. Cooling the battery pack 12 may reduce or slow pressure buildup within the battery cell 26.

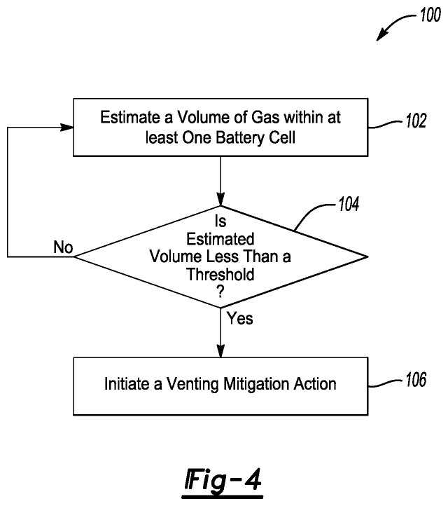

With reference to FIG. 4, a flow of an example method 100 of managing venting begins at a step 102 where an estimated volume of gas for a given battery cell is established. Next, at a step 104, the method 100 assesses whether the predicted venting time established in the step 102 is less than a threshold, say thirty days or thirty drive cycles from now. If the predicted venting time is less than the threshold, the method 100 moves to the stop 106, which initiates a venting mitigation action that is at least in partially based on the predicted venting time established in the step 102. The venting mitigation action can lead to an increase in the predicted venting time when the mathematical model is next run.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery venting management method, comprising:
initiating a venting mitigation action that is based in part on an estimated volume of gas within at least one battery cell within a traction battery pack.

2. The traction battery venting management method of claim 1, wherein the venting mitigation action comprises an adjusting of an upper state of charge limit for the at least one battery cell, the traction battery pack, or both.

3. The traction battery venting management method of claim 1, wherein the venting mitigation action comprises derating a maximum power capacity of the at least one battery cell, the traction battery pack, or both.

4. The traction battery venting management method of claim 1, wherein the venting mitigation action comprises derating a charging of the at least one battery cell, the traction battery pack, or both.

5. The traction battery venting management method of claim 1, further comprising initiating the venting mitigation action before a venting of the at least one battery cell.

6. The traction battery venting management method of claim 1, wherein the estimated volume of gas within the at least one battery cell is used to establish a predicted venting time for the at least one battery cell.

7. The traction battery venting management method of claim 6, wherein the predicted venting time is at least partially based on estimating when a pressure of gas within the at least one battery cell will exceed a venting threshold value.

8. The traction battery venting management method of claim 6, wherein the predicted venting time is based, at least in part, on both calendar aging and cycling aging.

9. The traction battery venting management method of claim 1, further comprising establishing the estimated volume of gas by running a mathematical model.

10. The traction battery venting management method of claim 9, wherein the traction battery pack is a constituent of an electrified vehicle.

11. The traction battery venting management method of claim 10, further comprising running a mathematical model at a start of a drive cycle for the electrified vehicle.

12. The traction battery venting management method of claim 11, wherein the venting mitigation action comprises servicing the electrified vehicle.

13. The traction battery venting management method of claim 9, wherein the mathematical model is a semi-empirical mathematical model.

14. The traction battery venting management method of claim 9, wherein running the mathematical model provides an estimate of gas volume by a power law with time.

15. The traction battery venting management method of claim 1, wherein the at least one battery cell comprises a lithium nickel manganese cobalt oxide cathode.

16. The traction battery venting management method of claim 1, wherein the at least one battery cell is a pouch cell.
